(19) United States
(12) Patent Application Publication
(10) Pub. No.: US 2006/0099123 A1
(43) Pub. Date: May 11, 2006

(54) Utilisation of waste gas streams

(76) Inventors: Andrew James Seeley, Bristol (GB); James Robert Smith, Blackford Somerset (GB)

Correspondence Address: THE BOC GROUP, INC., 575 MOUNTAIN AVENUE, MURRAY HILL, NJ, 07974-2064, US

(21) Appl. No.: 10/524,927

(22) PCT Filed: Aug. 22, 2003
(86) PCT No.: PCT/GB03/03670

§ 371 Date: Sep. 29, 2005

(30) Foreign Application Priority Data
Aug. 23, 2002 (GB) 0219735.8

(51) Int. Cl. B01D 53/34

(52) U.S. Cl. 423/237

(57) ABSTRACT

In a process and apparatus for utilisation of an ammonia-containing waste gas stream from a semiconductor processing step, ammonia contained in the waste gas stream is decomposed, for example, in a reactor (3), into hydrogen and nitrogen, the gas stream so obtained is passed through a hydrogen separator (5) in order to separate hydrogen gas therefrom, the separated hydrogen gas is purified in a purifier (8), and the purified hydrogen gas is recycled for use in semiconductor processing. The process and apparatus allow efficient usage of semiconductor processing waste gases by permitting recycling of a component thereof.

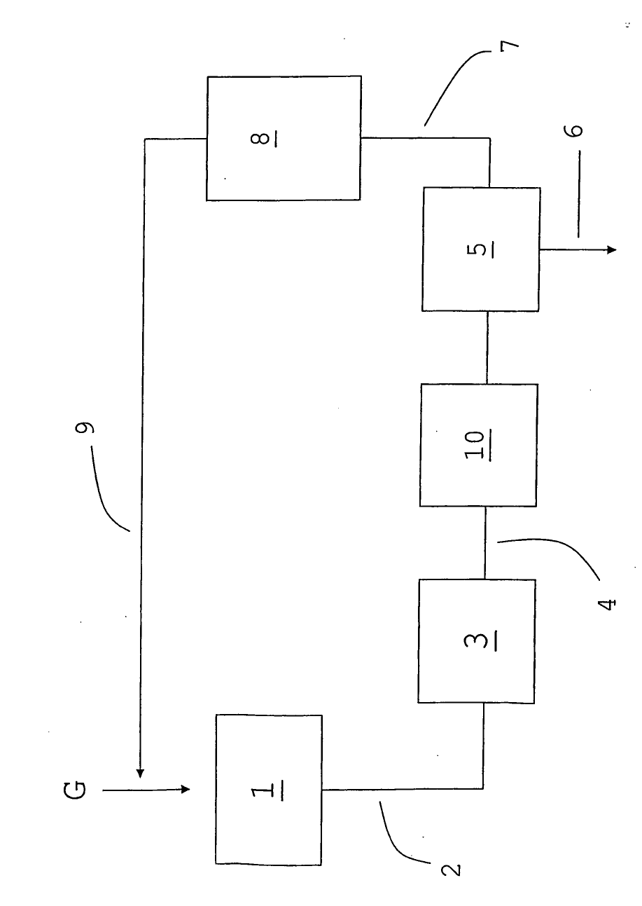

This invention relates to new methods of treating waste gas streams and, more particularly, to one in which hydrogen present in such waste gas streams is purified for re-use.

Hydrogen gas is increasingly employed in the processing of silicon semiconductor and compound semiconductor devices including the manufacture of light emitting diodes (LEDs). The hydrogen gas tends to be purified in situ on the processing site immediately before use by passing it through a palladium diffuser body which separates impurities from the gas. However, due to the extreme flammability there is an increasing demand to treat the gas as an alternative to discharging it at roof top level.

Ammonia is also a major constituent of many semiconductor processes and is often used concurrently with, or sequenced with, hydrogen. For example, ammonia is in particular used in the manufacture of nitride films on substrates in the production of various semiconductor components, and particularly LEDs. Blue LEDs are in particular useful in display screens, in particular, TV or computer display screens, in lighting and other devices, and the manufacture of semiconductor devices comprising gallium nitride (GaN), which give rise to emitted light in the blue part of the spectrum, has become widespread. Gallium nitride films are in general formed by epitaxial growth using, for example, molecular beam epitaxy, metal organic chemical vapour deposition (MOCVD) or other chemical vapour deposition methods. The MOCVD process involves the reaction of an organometallic gallium compound, for example trimethyl or triethyl gallium, with ammonia to generate gallium nitride. The exhaust gases from the GaN epitaxial growth step thus include a high proportion of ammonia. It is also common for hydrogen to be used in the epitaxial growth step, for example as a carrier gas, or in other processing steps preceding or succeeding the GaN epitaxial growth step.

Ammonia is a pungent gas with a TLV of 25 ppm. However, when burned, great care is needed to prevent the formation of NOx, whilst known wet scrubbing processes may well eventually de-gas the ammonia and/or result in high nitrate discharge rates into ground water.

It is known that a hot, packed bed containing a suitable catalyst can decompose ammonia into its constituent gases, nitrogen and hydrogen, to produce one part nitrogen and three parts hydrogen (by volume). This is an endothermic process and the gases and the catalyst need to be heated, for example, in accordance with the disclosure of our British Patent Application No. 2 353 034 A. Other ingredients can be added to the hot bed to remove other gases or vapours which may co-discharge from the reactor.

It is also known that simply burning hydrogen is a common alternative to high level atmospheric discharge. However, specific issues arise, in particular that standard burners need to possess adequate air added at all times to ensure complete combustion; in addition, large quantities of heat are generated which need to be managed through considerable additional engineering of plant and increased costs. Furthermore, concerns about “flashback” of hydrogen and oxidant mixtures also need to be managed.

There is a need to provide a more effective and/or efficient way of managing effluent gas from semiconductor processing.

In accordance with the invention, there is provided a process for utilisation of an ammonia-containing waste gas stream from a semiconductor processing step, comprising decomposing ammonia contained in the waste gas stream into hydrogen and nitrogen, passing the gas stream so obtained through a hydrogen separator in order to separate hydrogen gas therefrom, purifying the separated hydrogen gas in a purifier and using the purified hydrogen gas in semiconductor processing.

The gases required for use in the semiconductor processing industry are required to have very high purity levels in order to avoid contamination of the semiconductor devices, which may detrimentally affect the performance and/or lifetime of the devices. The inventors have found that, surprisingly, it is possible for waste gases containing ammonia to be treated to recover at least a substantial proportion of the hydrogen component of the ammonia and to recycle that hydrogen for use in semiconductor processing whilst nonetheless meeting the purity levels required in semiconductor processing.

Advantageously, the ammonia-containing waste gas stream is waste gas from gallium nitride epitaxial deposition. The hydrogen may then be recycled for use in that gallium nitride deposition, or for use in a semiconductor processing step upstream or downstream of that gallium nitride deposition step. Preferably, the semiconductor processing step is gallium nitride epitaxy, the purified hydrogen gas being recycled for use therein.

Advantageously, the hydrogen separator is a pressure swing adsorption system. The pressure swing adsorption system may use any suitable adsorption material (adsorbent).

Advantageously, the ammonia decomposition step comprises contacting the ammonia with a hot catalyst. Advantageously, the hydrogen gas effluent from the hydrogen separator has a purity of at least 99%. For example, the hydrogen produced using a pressure swing adsorption system as hydrogen separator in the process and apparatus of the invention, using known adsorbents, may be in excess of 99%, often in excess of 99.9% pure. The pressure swing adsorbents in the pressure swing adsorption system will generally be effective in separating the hydrogen from nitrogen in particular. They are therefore effective in separating hydrogen gas itself from a gas mixture or in separating the hydrogen gas constituent of ammonia (including any hydrogen gas itself which is present) from the gas mixture.

Advantageously, the purified hydrogen effluent from the purifier has a purity of at least 99.9%. By way of example, hydrogen of purity in excess of 99%, especially in excess of 99.9% pure, can be passed through a palladium purifier to produce hydrogen gas of purity of, or in excess of, 99.999%.

Advantageously, the hydrogen gas effluent from the hydrogen separator is combined with fresh hydrogen before it is purified in the purifier. Alternatively, or as well, the purified gas effluent from the purifier may be combined with further hydrogen and the combined hydrogen gas stream utilised in semiconductor processing. The supplementation of purified effluent with further hydrogen is particularly useful during semiconductor processing steps where the instantaneous demand for hydrogen is greater than the amount of hydrogen available as purified effluent.

The invention also provides an apparatus for manufacture of semiconductor products, having a semiconductor processing device and a waste gas recovery loop for recovery of hydrogen, the waste gas recovery loop comprising an ammonia cracking device for receiving waste gases from the semiconductor processing devices and decomposing ammonia therein to form a cracking device effluent containing nitrogen and hydrogen, a hydrogen separator for separation of hydrogen from the ammonia cracking device effluent, a purifier for purifying the separated hydrogen, and a recycle line for recycling purified hydrogen from the purifier to the semiconductor processing device. Advantageously, the semiconductor processing device is a gallium nitride epitaxy chamber. Preferably, the hydrogen separator is a pressure swing adsorbent system. Preferably, the hydrogen purifier is a palladium purifier.

Advantageously, the apparatus is so arranged that it can treat a waste gas flow of from 5 to 80 litres per minute. It will be appreciated that the capacity of the hydrogen separator will need to exceed that of the ammonia cracking device. The capacity of the hydrogen separator is advantageously from 5 to 360 litres per minute. The capacity of the palladium purifier is advantageously from 5 to 220 litres per minute.

One illustrative embodiment of the invention will now be described in detail with reference to the accompanying drawing, which is a schematic diagram of an apparatus according to the invention.

Referring to the drawing, the apparatus has a reactor chamber 1 into which is fed an organogallium compound G in a stream of carrier gas. The organogallium compound is introduced into a carrier gas by bubbling hydrogen carrier gas through a container of the liquid organogallium chemical. The entrained organogallium compound is then mixed with additional hydrogen, ammonia and nitrogen before being admitted into the reactor chamber. The gaseous mixture is then caused to uniformly contact the heated wafers on which the GaN is required to deposit. Epitaxial formation of gallium nitride occurs on a substrate in the chamber 1, with the organogallium compound reacting with ammonia to produce gallium nitride. Unreacted ammonia, together with hydrogen and gaseous reaction by-products are removed via line 2 and delivered into ammonia cracker 3, via a vacuum pump (not shown) which would ordinarily either be associated with the reactor chamber 1 or exist as a stand alone component. The ammonia cracker 3 contains a heated catalyst which catalyses decomposition of ammonia to hydrogen and nitrogen. The effluent gas from cracker 3 is fed via line 4 and a compressor 10 to pressure swing adsorption system 5 in which the hydrogen is separated from the nitrogen and other gases. The compressor 10 takes in gas at about atmospheric pressure and compresses the gas to about 5-10 psi (about 0.35-0.7 bar) above atmospheric pressure. Alternatively, the compressor 10 may be omitted and the vacuum pump may be modified to generate gas at its exhaust at a pressure of about 5-10 psi above atmospheric pressure. The pressure swing adsorption system 5 contains a suitable adsorbent, for example one or more of zeolite molecular sieves, activated carbon, silica gel and activated alumina. Such swing adsorption systems are commercially available from Questair Inc., Canada, and typically comprise a pair of PSA beds or columns and associated change-over valves which are so arranged that, whilst one bed or column is in use, the other is being regenerated. The cycling frequency between the beds or columns is so chosen that efficient separation is sustainable essentially without interruption, thereby enabling a continuous stream of separated hydrogen to be obtained. The swing adsorption system 5 is used to separate the hydrogen from the nitrogen and other gases using an appropriate pressure cycling regime. The use of pressure swing adsorption systems to separate hydrogen from nitrogen is well-known in the art and the selection of suitable devices and conditions will be a matter of routine for those skilled in the art. Nitrogen is removed through line 6 for venting to the atmosphere, after further cleansing if appropriate. The separated hydrogen will typically have a purity of 99 to 9.9%, with the balance in general being made up principally of nitrogen with minor amounts of other contaminants. In the case of some waste gas streams, solid particles may be inherently present or may be formed upon treatment in the cracking device. In such cases, a filter may be incorporated at the outlet of the cracking device 3 or in line 4 for the removal of particulates.

The separated hydrogen is fed via line 7 to a palladium purifier 8 in which residual nitrogen and other impurities are removed in known manner. Following purification in palladium purifier 8, the hydrogen is recycled via line 9 to be combined with the organogallium compound G for injection therewith into chamber 1.

Although in the embodiment shown the hydrogen is recycled to be used in the chamber 1, it may instead be recycled to a different reactor or chamber in which a different semiconductor processing step is being carried out, for example a step upstream or downstream of that carried out in the chamber 1.

Whilst there is described above a pressure swing adsorption system comprising two pressure swing adsorption beds or columns arranged in parallel, it is possible in principle to use a single bed. In some circumstances, that may be simpler and cheaper, but it will be appreciated that that bed will preferably have a capacity for impurities sufficient for all the non-hydrogen components of the waste stream being processed. As the single bed or column will have no capacity for recycling hydrogen whilst it is being regenerated to remove collected impurities, provision would be required for supplying supplementary fresh hydrogen to the semiconductor process if that process is to continue in operation during the regeneration phase. Thus, use of pressure swing adsorption systems comprising a pair of beds or columns operating in parallel is especially preferred when there is a relatively long process time and short down-time. A short down-time means that there is little time in which to regenerate the adsorbent in the pressure swing adsorption systems. In many cases it would be impractical to regenerate the adsorbent between process steps. Furthermore, whilst for simplicity the embodiment described is shown in the drawing as having a single epitaxy chamber 1, the recycle line including the cracking device 3, hydrogen separator 5 and purifier 8 may receive waste gases from two or more chambers and/or may supply recycled hydrogen to two or more chambers.

1. A process for utilization of an ammonia-containing waste gas stream from a semiconductor processing step, comprising decomposing ammonia contained in the waste gas stream into hydrogen and nitrogen, passing the gas stream so obtained through a hydrogen separator in order to separate hydrogen gas therefrom, purifying the separated hydrogen gas in a purifier and using the purified hydrogen gas in semiconductor processing.

2. A process according to claim 1, in which the semiconductor processing step is gallium nitride epitaxy, the purified hydrogen gas being recycled for use therein.

3. A process according to claim 1, in which the hydrogen separator is a pressure swing adsorption system.

4. A process according to claims 1, in which the purifier is a palladium purifier.

5. A process according to claims 1, in which the ammonia decomposition step comprises contacting the ammonia with a hot catalyst.

6. A process according to claims 1, in which the hydrogen gas effluent from the hydrogen separator has a purity of at least 99%.

7. A process according to claims 1, in which the purified hydrogen effluent from the purifier has a purity of at least 99.99%.

8. A process according to claims 1, in which the hydrogen gas effluent from the hydrogen separator is combined with fresh hydrogen before it is purified in the purifier.

9. A process according to claims 1, in which the purified gas effluent from the purifier is combined with further hydrogen and the combined hydrogen gas stream is utilized in semiconductor processing.

10-13. (canceled)

14. A process according to claim 2, in which the hydrogen separator is a pressure swing adsorption system.

15. A process according to claim 2, in which the purifier is a palladium purifier.

16. A process according to claim 2, in which the ammonia decomposition step comprises contacting the ammonia with a hot catalyst.

17. A process according to claim 6, in which the hydrogen gas effluent from the hydrogen separator is combined with fresh hydrogen before it is purified in the purifier.

18. A process according to claim 7, in which the purified gas effluent from the purifier is combined with further hydrogen and the combined hydrogen gas stream is utilized in semiconductor processing.

19. An apparatus for manufacture of semiconductor products, having a semiconductor processing device and a waste gas recovery loop for recovery of hydrogen, the waste gas recovery loop comprising an ammonia cracking device for receiving waste gases from the semiconductor processing devices and decomposing ammonia therein to form a cracking device effluent containing nitrogen and hydrogen, a hydrogen separator for separation of hydrogen from the ammonia cracking device effluent, a purifier for purifying the separated hydrogen, and a recycle line for recycling purified hydrogen from the purifier to the semiconductor processing device.

20. An apparatus according to claim 19, in which the semiconductor processing device is a gallium nitride epitaxy chamber.

21. An apparatus according to claim 20, in which the hydrogen separator is a pressure swing absorption system.

22. An apparatus according to claim 20, in which the hydrogen purifier is a palladium purifier.
